(19) United States
(12) Patent Application Publication
(10) Pub. No.: US 2007/0230194 A1
(43) Pub. Date: Oct. 4, 2007

(54) Submersible spotlight

(75) Inventor: Joan Julia Vilarrasa, Sant Jaume de Llierca (ES)

Correspondence Address: MERCHANT & GOULD PC, P.O. BOX 2903, MINNEAPOLIS, MN, 55402-0903, US

(73) Assignee: Sacopa, S.A.U., Sant Jaume de Llierca (ES)

(21) Appl. No.: 11/715,523

(22) Filed: Mar. 8, 2007

(30) Foreign Application Priority Data
Mar. 28, 2006 (ES) ES 200600703 U

(51) Int. Cl. F21V 29/00; F21V 31/00

(52) U.S. Cl. 362/373; 362/267

(57) ABSTRACT

A spotlight includes a body (1) with a transparent front (2) and has LED's (5) as light-emitting elements. This spotlight body (1) and the transparent front (2) are made of plastic material and the printed circuit (6) including the LED's (5) is arranged in a juxtaposed arrangement on a metal plate (4) being fit to dissipate the heat being produced by the LED's, the metal plate being cooled by the water flowing into the body (1) of the spotlight through lateral openings (8) being provided in the body. The body (1) is concavely shaped and has the dissipator plate (4) securely attached to it at its open front end, the body (1) having at its center an inner pillar having a hollowed-out portion (10) and an outer open end (11) to receive the spotlight's electric connections (13 and 14) that will be fitted to it. The dissipator plate (4) is securely attached to the peripheral open front end of the body (1) and onto its central pillar (9) with the intermediary of respective O-ring seals (15 and 16).

### FIELD OF THE INVENTION

This spotlight is mainly designed for the lighting of swimming pools in a water-submerged state, but it can also be used for ornamental fountains and even as a light projector outside the water.

### BACKGROUND OF THE INVENTION

Different types of submersible spotlights are already known, parabolic lamps having been used for some time now which are known as “PAR 56” and are formed by a body and a lens being both made of glass, said lamps comprising as a light-emitting element an incandescent filament bulb, the body having an inner metal coating serving as a reflector. In this kind of spotlights LED's have been recently used instead of the bulb, said LED's possibly being of different colors such as for example red, blue and green, in order to thus obtain different lighting combinations, the body being made of metal and the lens being made of glass.

### SUMMARY OF THE INVENTION

The object of the invention is a submersible spotlight of the type comprising as light-emitting elements LED's possibly being all white or of different colors. This novel light-emitting spotlight represents a notable improvement to the manufacture of this kind of submersible spotlights, a characterizing feature lying in the fact that the body and the glass are each obtained as a molding being made of plastics material, their manufacture being thus sensibly simplified and their cost being thus more reduced, both members thus forming a solid and undeformable assembly.

An also characterizing feature lies in the cooling mode being used in order to evacuate the heat being produced by the LED's. The printed circuit comprising the LED's is for such a purpose arranged in a juxtaposed arrangement on a metal plate being provided for dissipating said heat, said metal plate being cooled by the water flowing into the spotlight body, this latter for such a purpose having lateral openings being provided therein.

The electric connections of the spotlight are arranged at a hollow pillar being provided at the center of the body and having an outer open end, said electric connections being thus isolated from the water flooding said body.

The dissipator plate is securedly attached to the open front end of the body having a concave make-up, and onto the central pillar with the intermediary of seals allowing to tightly seal the cooling chamber being formed in the body.

These and other characterizing features will be best made apparent by the following detailed description whose understanding will be made easier by the accompanying sheet of drawings showing a practical embodiment being cited only by way of example not limiting the scope of the present invention.

### DESCRIPTION OF THE DRAWINGS

In the drawings:

FIGS. 1 and 2 show the submersible spotlight being the object of the invention as seen in a perspective view and in a plan-view, respectively;

FIG. 3 illustrates in an elevational view the aforementioned spotlight without the transparent front; and

FIG. 4 is a cross-sectional view of the spotlight.

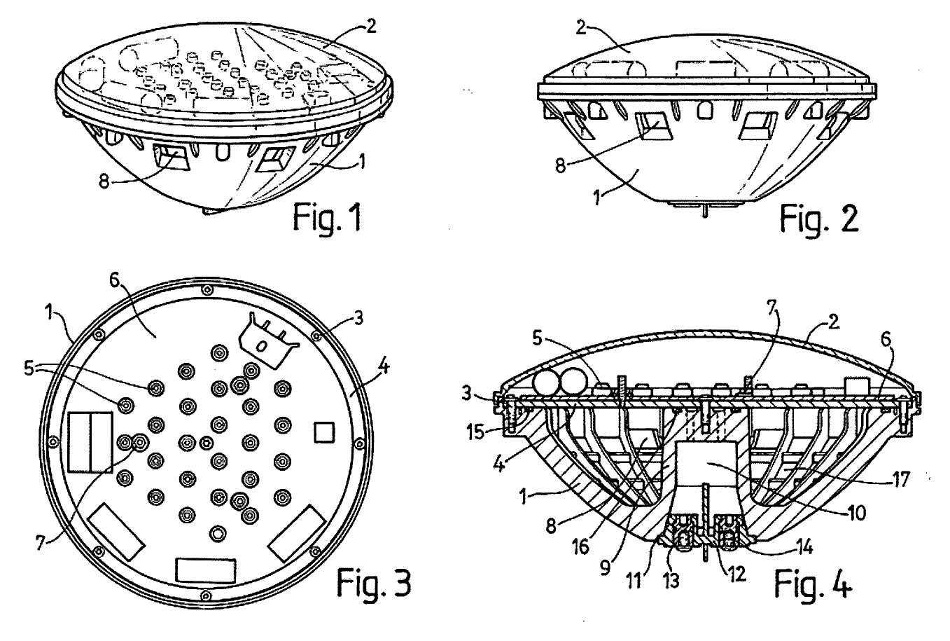

### DETAILED DESCRIPTION

According to the drawings this submersible spotlight comprises a body (1) and a transparent front (2) (lens) being made of plastics material, both parts being welded together and thus tightly fitted to each other in a sealed arrangement.

The body (1) is concavely shaped and has a rustproof metal plate (4) securedly attached to it at its open front end by means of screws (3), said metal plate being provided for dissipating the heat being generated by the LED's (5) being connected to the printed circuit (6) being securedly attached in a juxtaposed arrangement onto said plate by means of nuts (7).

The dissipator plate (4) is cooled by the water that will flow into the body (1) through openings (8) being laterally provided in its concave wall.

At the center of the body (1) there exists an inner pillar (9) forming a hollowed-out portion (10) with an outer open end (11) being fit to receive a stopper (12) that will be tightly fitted to it in a sealed arrangement and comprises sockets (13) and (14) for the electric connection of the spotlight.

The dissipator plate (4) is securedly attached to the peripheral open front end of the body (1) and onto the central pillar (9) with the intermediary of respective O-ring seals (15) and (16) thus tightly sealing the chamber (17) being formed in the body (1) for receiving the water flowing into it.

This submersible spotlight has the format of the “PAR 56” parabolic lamps and is hence in a position to replace them and to thus produce the aforementioned multicolor effects while at the same time notably reducing the power consumption and reaching a longer duration. This spotlight can form part of a lighting system being actuated by a radio remote control.

1. A submersible spotlight comprising a body with a transparent front and having LED's as light-emitting elements, wherein the body and the transparent front are made of plastic material and a printed circuit comprising the LED's is arranged in a juxtaposed arrangement on a metal plate configured to dissipate the heat being produced by said LED's, said metal plate being cooled by the water flowing into the body of the spotlight through lateral openings in said body.

2. A submersible spotlight as per claim 1, wherein the body is concavely shaped and has the dissipator plate attached to it at its open front end, said body having at its center an inner pillar having a hollowed-out portion and an outer open end adapted to receive the spotlight's electric connections that will be fitted to it.

3. A submersible spotlight as per the claim 1, wherein the dissipator plate is attached to the peripheral open front end of the body and onto its central pillar with the intermediary of respective O-ring seals.

4. A submersible spotlight as per claim 2, wherein the dissipater plate is attached to the peripheral open front end of the body and onto its central pillar with intermediate respective O-rings seals.
